(19) United States
(12) Patent Application Publication
(10) Pub. No.: US 2026/0204814 A1
(43) Pub. Date: Jul. 16, 2026

(54) TERMINAL BLOCK

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 19/021,068

(22) Filed: Jan. 14, 2025

(51) Int. Cl. H01R 9/24; H01R 4/48; H01R 4/50

(52) U.S. Cl. CPC H01R 9/2416; H01R 4/4811; H01R 4/4833; H01R 4/5008

(57) ABSTRACT

This disclosure is directed to a terminal block having an insulative seat, a conductive piece, an elastic piece, a slider and a cam. The insulative seat has a coupling room disposed in the insulative seat, a socket hole disposed on a surface of the insulative seat and communicated with the coupling room and a sliding track connected between the surface of the insulative seat and the coupling room. The conductive piece is arranged in the insulative seat and extended into the coupling room. The elastic piece is arranged in the coupling room and provided with an elastic arm extended toward the conductive piece. The slider is movably inserted in the sliding track and the slider has a pushing pin and a first claw. The cam is pivoted to the insulative seat has a first trigger and a second claw for engaging the first claw when the first trigger is pushed.

### BACKGROUND OF THE INVENTION

### Technical Field

This disclosure is directed to a terminal block, in particular to a terminal block easy for coupling a conductive wire.

### Description of Related Art

A terminal block is an electronic component widely used in various machines or tools having electrical connection requirements, and specifically used for connecting power lines, control lines or data transmission lines.

When conductive wires are plugged to a terminal block of related art, a pressing member so called a handle usually should be press via a tool such as a slotted screwdriver to retreat an elastic piece in the terminal block and further allow the conductive wires to be inserted and positioned. Then the pressing member is released to allow the elastic piece to clamp the conductive wire for an electrical connection. In the operation mentioned above, a user should operate a tool with one hand to keep pressing the pressing member and meanwhile insert the conductive wire with the other hand, so the operation is inconvenient.

In views of this, in order to solve the above disadvantage, the inventor studied related technology and provided a reasonable and effective solution in this disclosure.

### SUMMARY OF THE INVENTION

This disclosure is directed to a terminal block which is easy for coupling a conductive wire.

This disclosure is directed to a terminal block, used for coupling a conductive wire, the terminal block has an insulative seat, a conductive piece, an elastic piece, a slider and a cam. The insulative seat has a coupling room, a socket hole and a sliding track. The coupling room is disposed in the insulative seat, the socket hole is disposed on a surface of the insulative seat and communicated with the coupling room, and the sliding track is communicated between the surface of the insulative seat and the coupling room. The conductive piece is arranged in the insulative seat and extended into the coupling room. The elastic piece is arranged in the coupling room and the elastic piece has an elastic arm extended toward the conductive piece. The slider is movably inserted in the sliding track and the slider has a pushing pin and a first claw. The cam is pivoted to the insulative seat and provided with a second claw and a first trigger. The slider is allowed to move into the coupling room to abut the elastic arm by the pushing pin to cause an elastic deformation on the elastic piece, so that the elastic arm is moved away from the conductive piece to push the first trigger, and the first claw is moved to the second claw. The cam is rotated to move the second claw toward the first claw to engage the first claw when the first trigger is moved by the elastic piece so as to fix the slider with the elastic piece.

In one embodiment of this disclosure, the cam has a second trigger, the second trigger is disposed corresponding to a central line of the socket hole, when the conductive wire is inserted into the coupling room through the socket hole to abut the second trigger, the cam is reversed to release the second claw from the first claw, the elastic piece is recovered and the elastic arm is rest to press the conductive wire on the conductive piece.

In one embodiment of this disclosure, the cam has a second trigger, the second trigger is disposed corresponding to a central line of the socket hole, when the conductive wire is inserted into the coupling room through the socket hole to abut the second trigger, the cam is reversed to release the second claw from the first claw, the elastic piece is recovered and the elastic arm is rest to push the slider out of the coupling room.

In one embodiment of this disclosure, the second trigger and the socket hole are disposed opposite to each other at a bottom of the coupling room.

In one embodiment of this disclosure, the conductive piece and the elastic piece are disposed opposite to each other at two sides of the socket hole.

In one embodiment of this disclosure, the first trigger and the elastic arm are disposed together at one side of the socket hole opposite to the conductive piece.

In one embodiment of this disclosure, the elastic arm is extended from one side of the socket hole across a central line of the socket hole.

In one embodiment of this disclosure, the conductive piece has a stopping latch, the stopping latch buckles an end of the elastic arm.

In one embodiment of this disclosure, a connecting channel is defined between the pushing pin and the first claw, the elastic arm is extended through the connecting channel.

Accordingly, the terminal block of this disclosure has a slider that can be pressed down to retract the elastic arm, so as to facilitate further insertion of the conductive wire. When the conductive wire is inserted to a predetermined position, the conductive wire can trigger the cam to release the elastic arm and reset the elastic arm, so that the conductive wire is locked, and the slider is reset meanwhile. Therefore, a conductive wire can be coupled to the terminal block of this disclosure without a tool.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is an exploded view of a terminal block according to this disclosure.

FIG. 2 is a perspective view showing a slider of the terminal block according to this disclosure.

FIG. 3 is a perspective view showing a cam of the terminal block according to this disclosure.

FIG. 4 is a perspective view showing the terminal block according to this disclosure.

FIG. 5 is a normal view of the terminal block according to this disclosure.

FIG. 6 is a perspective view showing the terminal block in operation in an initial status.

FIG. 7 is a perspective view showing an elastic arm of the terminal block in operation released by the slider.

FIG. 8 is a perspective view showing the cam of the terminal block in operation in a released status.

FIG. 9 is a perspective view showing the terminal block in operation in a coupled status.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

It should be understood that the orientations or positional relationships in this disclosure which are indicated by the terms such as “front side”, “rear side”, “left side”, “right side”, “front end”, “rear end”, “end”, “vertical”, “horizontal”, “vertical”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Detailed descriptions and technical contents of this disclosure is described in the flowing paragraph with reference to the drawings. However, the drawings are attached only for illustration and are not intended to limit this disclosure.

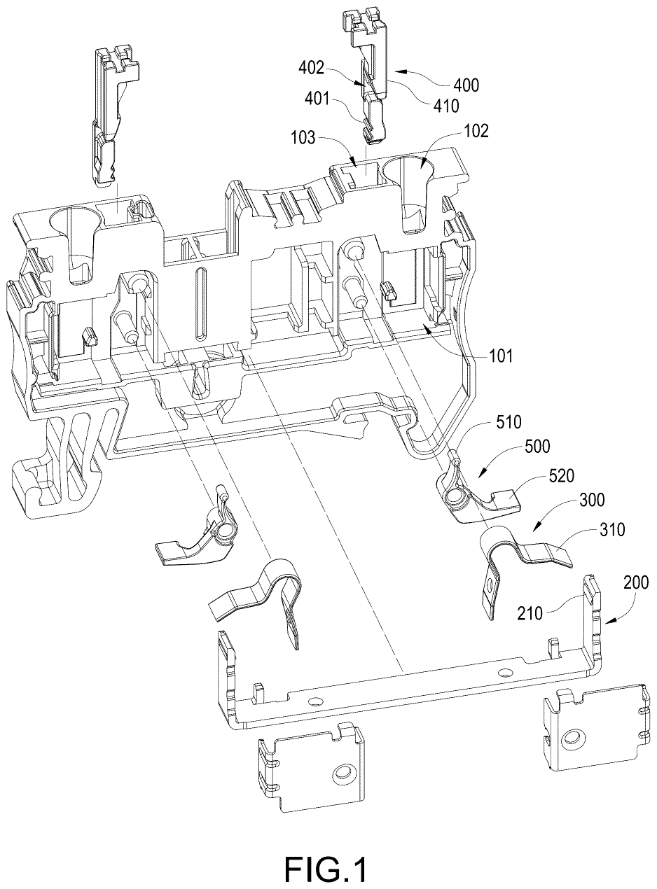

FIG. 1 is an exploded view of a terminal block according to this disclosure. According to FIG. 1, one embodiment of this disclosure is directed to a terminal block having an insulative seat 100, a conductive piece 200, an elastic piece 300, a slider 400 and a cam 500.

According to this embodiment, the insulative seat 100 is a flat block made of plastic. The insulative seat 100 has at least a coupling room 101, a socket hole 102 and a sliding track 103 corresponding to the coupling room 101, the coupling room 101 is disposed in the insulative seat 100, the socket hole 102 is disposed on surface at a periphery of the insulative seat 100, the socket hole 102 is communicated to the coupling room 101, and sliding track 103 is communicated between a surface of the insulative seat 100 and the coupling room 101. According to this embodiment, the sliding track 103 and the socket hole 102 are disposed together on a surface at the periphery of the insulative seat 100 and the respectively connected to a top of the coupling room 101, but the scopes of this disclosure should not be limited to this. In general, a plurality of terminal blocks are disposed in a group, a plurality of insulative seats 100 of the terminal block are up-right arranged so that the socket holes 102 and the sliding tracks 103 of the insulative seats 100 are opened upward.

According to this embodiment, the insulative seat 100 has a pair of coupling rooms 101 therein which have structures in mirror symmetry with each other and same function. A socket hole 102 and a sliding track 103 are disposed corresponding to each of the coupling rooms 101, but the coupling rooms 101 should not be limited to the number mentioned above. In the following paragraphs, only one of the coupling rooms 101 is taken as an example and illustrated with corresponding components and structures.

According to this embodiment, the conductive piece 200 is an elongated strip made of metal. The conductive piece 200 is embedded in the insulative seat 100 and at least one end of the conductive piece 200 is extended into the coupling room 101 correspondingly. According to this embodiment, two ends of the conductive piece 200 are respectively extended into the coupling rooms 101.

An elastic piece 300 is arranged in each of the coupling rooms 101, the elastic piece 300 has elastic arm 310 and the elastic piece 300 is extended in the coupling room 101 toward the conductive piece 200. According to this embodiment, the elastic piece 300 has a portion embedded in the insulative seat 100, thereby being fixed with the insulative seat 100. In each of the coupling rooms 101, the conductive piece 200 and the elastic piece 300 are disposed opposite to each other at two sides of the socket hole 102, and the elastic arm 310 is extended from one side of the socket hole 102 toward the conductive piece 200 to cross a central line of the socket hole 102. According to this embodiment, the conductive piece 200 mentioned above has a stopping latch 210, and the stopping latch 210 buckles an end of the elastic arm 310 to prevent the elastic arm 310 from a deformation out of the socket hole 102, so as to define an end of a path of the deformation of the elastic arm 310.

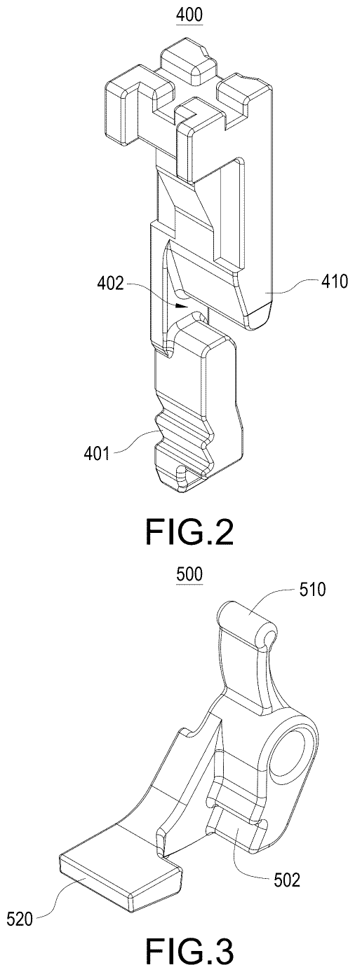

FIG. 2 is a perspective view showing a slider of the terminal block according to this disclosure. According to FIG. 2, the slider 400 has a pushing pin 410 and a first claw 401. The pushing pin 410 and the first claw 401 are separated from each other and a connecting channel 402 is defined between the pushing pin 410 and the first claw 401.

FIG. 3 is a perspective view showing a cam of the terminal block according to this disclosure. According to FIG. 3, the cam 500 is pivoted to the insulative seat 100, the cam 500 has a second claw 502, a first trigger 510 and a second trigger 520.

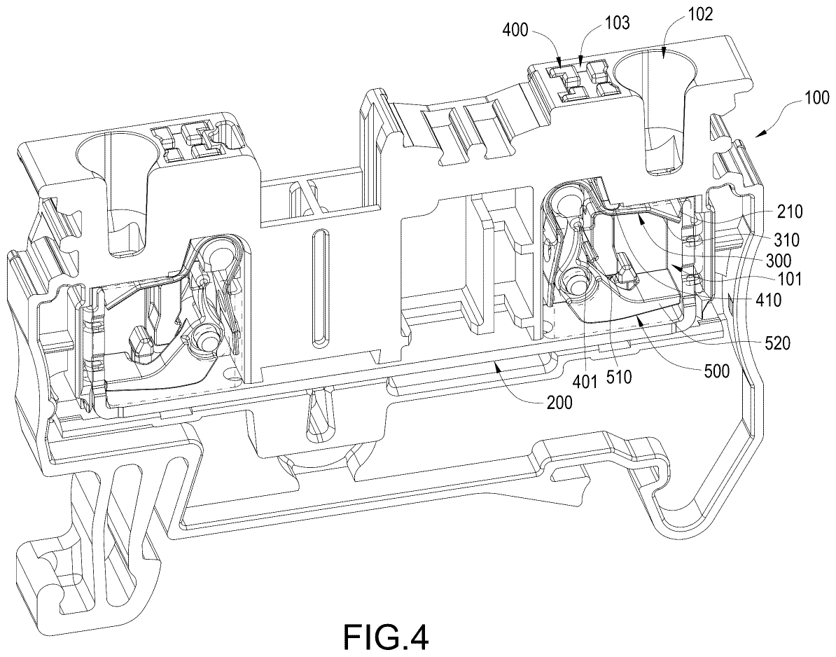

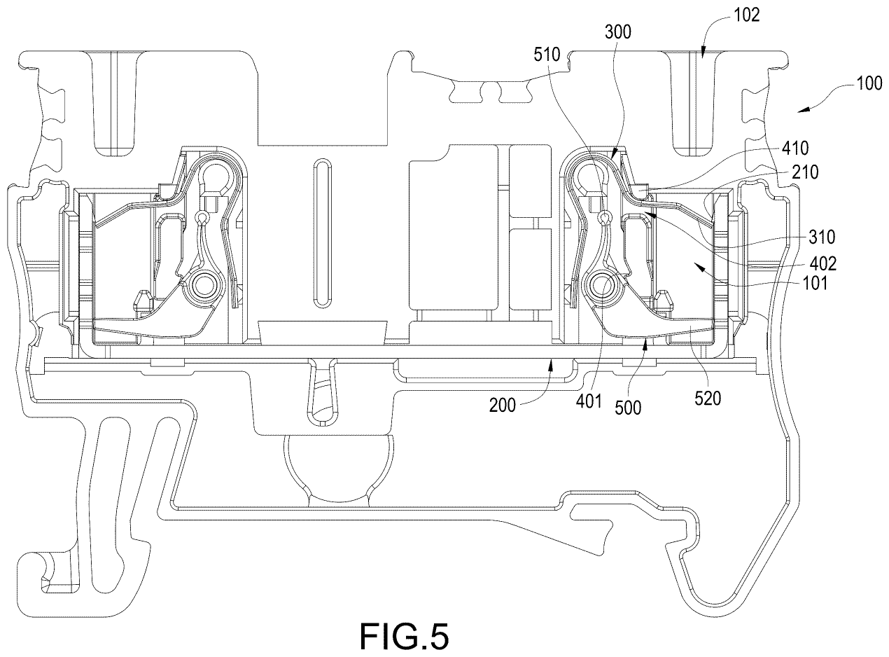

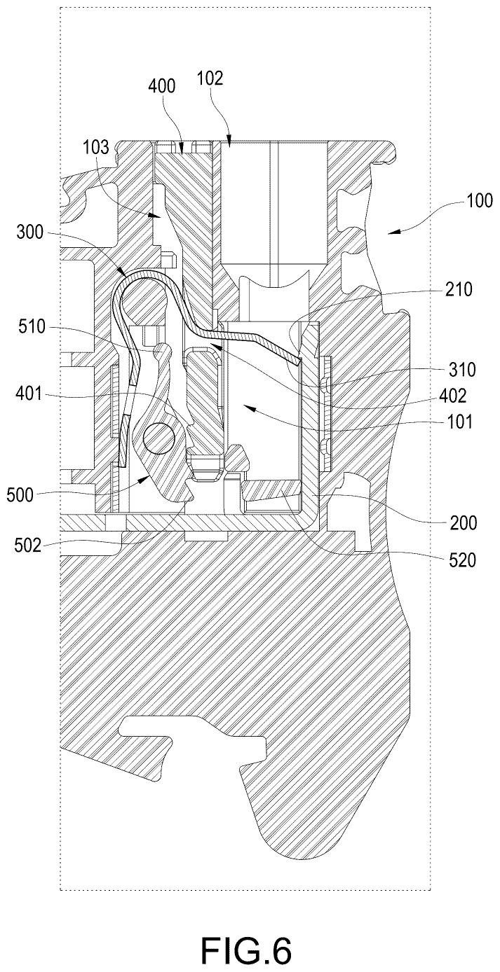

FIG. 4 is a perspective view showing the terminal block according to this disclosure. FIG. 5 is a normal view of the terminal block according to this disclosure. FIG. 6. is a perspective view showing the terminal block in operation in an initial status. According to FIGS. 4 to 6, the slider 400 is movably inserted in the sliding track 103, the elastic arm 310 of the elastic piece 300 is extended to the conductive piece 200 through the connecting channel 402 and cooperated with the stopping latch 210 to limit the slider 400 so as to prevent the slider 400 from falling out of the sliding track 103. According to this embodiment, the cam 500 and the elastic arm 310 are disposed together at a side of the socket hole 102. Specifically, the first trigger 510 and the elastic arm 310 are disposed together at one side of the socket hole 102 opposite to the conductive piece 200. The first trigger 510 is upright arranged, and the elastic arm 310 is extended downward. The second trigger 520 is disposed corresponding to the central line of the socket hole 102 and extended to cross the central line of the socket hole 102, and the second trigger 520 is disposed at a bottom of the coupling room 101 and opposite to the socket hole 102.

The slider 400 is allowed to move into the coupling room 101 to abut the elastic arm 310 by the pushing pin 410 to cause a deformation on the elastic piece 300 and the elastic arm 310 is moved away from the conductive piece 200 to push the first trigger 510, and the first claw 401 is meanwhile moved to the second claw 502 to be adjacent to the second claw 502. The cam 500 is rotated when the first trigger 510 is pushed by the elastic piece 300 as mentioned above, thereby move the second claw 502 toward the first claw 401 to engage the first claw 401 and further fix the slider 400 to resist against an elastic force on the slider 400 from the elastic arm 310, and the elastic arm 310 is meanwhile fixed by the slider 400 at a position away from the socket hole 102. The cam 500 is reversed by the second trigger 520 to release the second claw 502 from the first claw 401 when the second trigger 520 is pushed. The elastic arm 310 is reset (restored to its original position) when the elastic piece 300 is recovered, and the elastic arm 310 pushes the slider 400 out of the coupling room 101 to reset when the elastic arm 310 is reset.

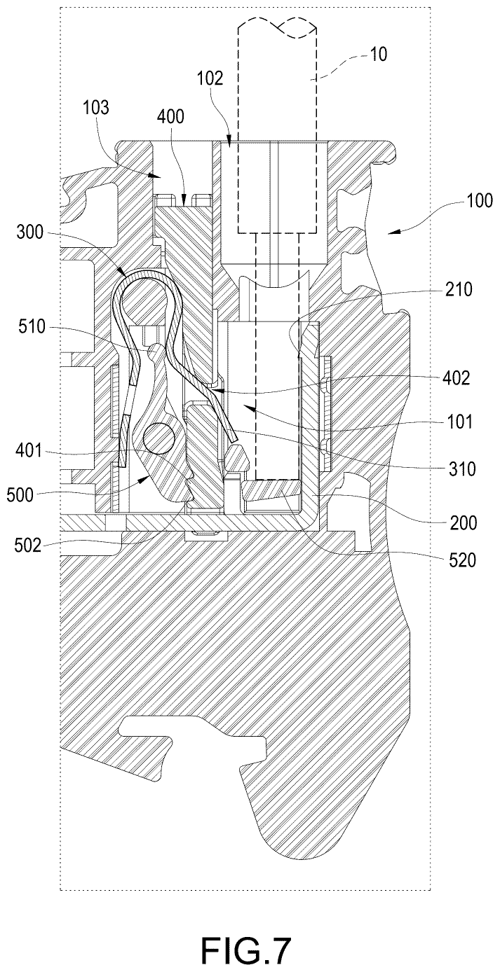

FIG. 7. is a perspective view showing an elastic arm 310 of the terminal block 400 in operation released by the slider. According to FIGS. 6 and 7, the terminal block of this disclosure is used for coupling with a conductive wire 10. Before coupling the conductive wire 10, The slider 400 should be pressed down from an initial position as shown in FIG. 6 into the coupling room 101 and to a position as shown in FIG. 7. When the slider 400 is located at the position as shown in FIG. 7, the elastic arm 310 is pressed by a pushing pin 410 on the slider 400 to cause an elastic deformation on the elastic piece 300, and the elastic arm 310 is further pushed toward the first trigger 510 from the conductive piece 200. When the elastic arm 310 abuts against the first trigger 510, the first claw 401 is meanwhile moved to the second claw 502 to be adjacent to the second claw 502. In the motion mentioned above, the elastic arm 310 presses the first trigger 510 and meanwhile rotates the cam 500 counterclockwise as shown in FIG. 7, thereby moving the second claw 502 toward the first trigger 510 to engage the first claw 401.

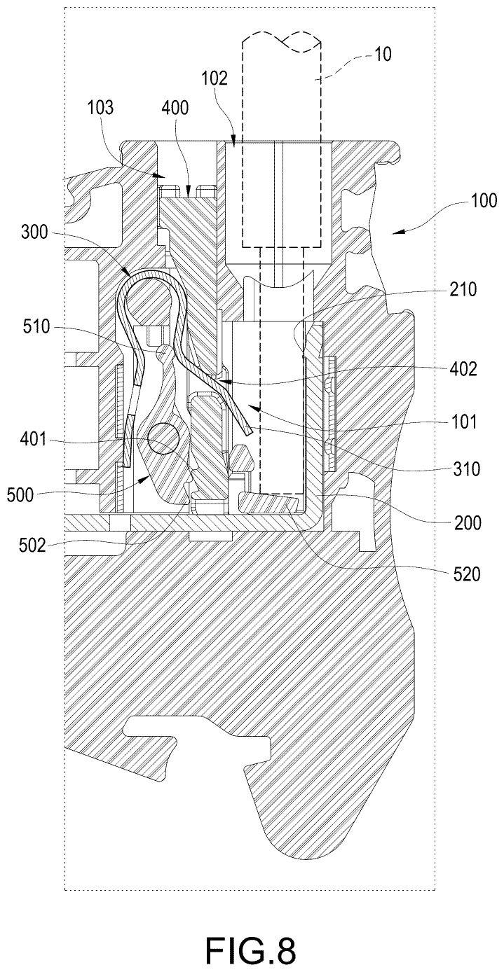

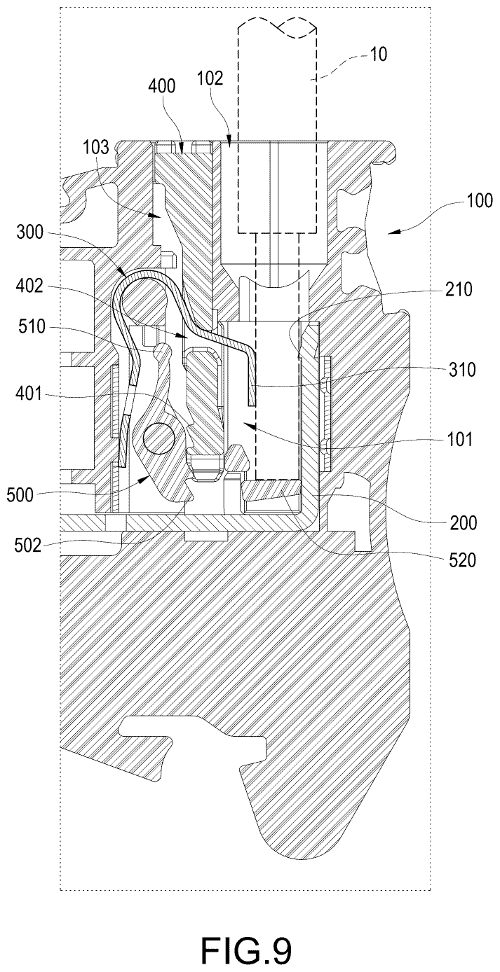

FIG. 8. is a perspective view showing the cam 500 of the terminal block 400 in operation in a released status. According to FIGS. 7 and 8, when the conductive wire 10 is inserted into the coupling room 101 through the socket hole 102 to abut the second trigger 520, the cam 500 is reversed clockwise, and the second claw 502 is released from the first claw 401. FIG. 9. is a perspective view showing the terminal block in operation in a coupled status. According to FIGS. 8 and 9, the second claw 502 releases the first claw 401 and the elastic piece 300 is then recovered to reset (restore to its original position) the elastic arm 310 to press the conductive wire 10 on the conductive piece 200. The elastic arm 310 is reset to push the slider 400 out of the coupling room 101 so that the slider 400 is reset.

Accordingly, referring to FIGS. 6 to 9, the elastic arm 310 of the terminal block of this disclosure may be retreated by pressing the slider 400 to allow the conductive wire 10 to be plugged therein. When the conductive wire 10 is plugged and positioned, the cam 500 is triggered by conductive wire 10 to release the elastic arm 310 so that the elastic arm 310 is reset to lock the conductive wire 10 and the slider 400 is reset meanwhile. Therefore, a wire coupling operation of the terminal block of this disclosure is tool-free.

While this disclosure has been described by means of specific embodiments, numerous modifications and variations could be made thereto by those skilled in the art without departing from the scope and spirit of this disclosure set forth in the claims.

What is claimed is

1. A terminal block, used for coupling a conductive wire, the terminal block comprising:
an insulative seat, comprising a coupling room, a socket hole and a sliding track, the coupling room disposed in the insulative seat, the socket hole disposed on a surface of the insulative seat and communicated with the coupling room, the sliding track communicated between the surface of the insulative seat and the coupling room;
a conductive piece, arranged in the insulative seat and extended into the coupling room;
an elastic piece, arranged in the coupling room and comprising an elastic arm extended toward the conductive piece;
a slider, movably inserted in the sliding track and comprising a pushing pin and a first claw; and
a cam, pivoted to the insulative seat and comprising a second claw and a first trigger,
wherein the slider is allowed to move into the coupling room to abut the elastic arm by the pushing pin to cause an elastic deformation on the elastic piece, so that the elastic arm is moved away from the conductive piece to push the first trigger, and the first claw is moved to the second claw; and
wherein the cam is rotated to move the second claw toward the first claw to engage the first claw when the first trigger is moved by the elastic piece so as to fix the slider with the elastic piece.

2. The terminal block according to claim 1, wherein the cam comprises a second trigger, the second trigger is disposed corresponding to a central line of the socket hole, when the conductive wire is inserted into the coupling room through the socket hole to abut the second trigger, the cam is reversed to release the second claw from the first claw, the elastic piece is recovered and the elastic arm is reset to press the conductive wire on the conductive piece.

3. The terminal block according to claim 1, wherein the cam comprises a second trigger, the second trigger is disposed corresponding to a central line of the socket hole, when the conductive wire is inserted into the coupling room through the socket hole to abut the second trigger, the cam is reversed to release the second claw from the first claw, the elastic piece is recovered and the elastic arm is reset to push the slider out of the coupling room.

4. The terminal block according to claim 2, wherein the second trigger and the socket hole are disposed opposite to each other at a bottom of the coupling room.

5. The terminal block according to claim 3, wherein the second trigger and the socket hole are disposed opposite to each other at a bottom of the coupling room.

6. The terminal block according to claim 1, wherein the conductive piece and the elastic piece are disposed opposite to each other at two sides of the socket hole.

7. The terminal block according to claim 1, wherein the first trigger and the elastic arm are disposed together at one side of the socket hole opposite to the conductive piece.

8. The terminal block according to claim 1, wherein the elastic arm is extended from one side of the socket hole across a central line of the socket hole.

9. The terminal block according to claim 1, wherein the conductive piece comprises a stopping latch, the stopping latch buckles an end of the elastic arm.

10. The terminal block according to claim 1, wherein a connecting channel is defined between the pushing pin and the first claw, the elastic arm is extended through the connecting channel.
